(19) United States
(12) Patent Application Publication
(10) Pub. No.: US 2021/0023874 A1
(43) Pub. Date: Jan. 28, 2021

(54) Single Construction Paint Roller Cleaners

(71) Applicant: Christoph S. Martinez, Shoreline, WA (US)

(72) Inventor: Christopher S. Martinez, Shoreline, WA (US)

(21) Appl. No.: 16/938,655

(22) Filed: Jul. 24, 2020

Related U.S. Application Data
(60) Provisional application No. 62/879,502, filed on Jul. 28, 2019.

(51) Int. Cl. B44D 3/00; B05C 17/02; B08B 3/04

(52) U.S. Cl. CPC B44D 3/006; B08B 3/04; B05C 17/0245

(57) ABSTRACT

Paint roller cleaning implements are described for allowing users to, among other things, wash and reuse or recycle paint rollers. A paint roller cleaning implement includes a first cylindrical structure sized and dimensioned to engage an inner surface of a paint roller frame of a first size; a second cylindrical structure sized and dimensioned to engage an inner surface of a paint roller frame of a second size different from the first; and a base structure configured to support and maintain a paint roller vertically. A portion of the first cylindrical structure is configured to fit within a paint roller frame and to form a seal sufficient to permit water to fill an inner cavity of the paint roller frame and cascade over an outer surface of a paint roller cover so as to wash off the paint.

### RELATED APPLICATIONS

This application claims the benefit of priority under 35 USC § 119(e) of U.S. Provisional Patent Application No. 62/879,502 filed Jul. 28, 2019, the contents of which are incorporated herein by reference in their entirety.

### SUMMARY

In an aspect, the present disclosure is directed to, among other things, a paint roller cleaning implement. In an embodiment, the paint roller cleaning implement includes a first cylindrical structure sized and dimensioned to engage an inner surface of a paint roller frame of a first size. In an embodiment, a portion of the first cylindrical structure is configured to fit within a standard paint roller frame and to form a seal sufficient to permit water to fill an inner cavity of the standard paint roller frame and cascade over an outer surface of a standard paint roller cover. In an embodiment, the paint roller cleaning implement includes a second cylindrical structure sized and dimensioned to engage an inner surface of a paint roller frame of a second size different from the first. In an embodiment, a portion of the second cylindrical structure is configured to fit within a mini paint roller frame and to form a seal sufficient to permit water to fill an inner cavity of the mini paint roller frame and cascade over an outer surface of a mini paint roller cover. In an embodiment, the paint roller cleaning implement includes a base structure configured to support and maintain a paint roller vertically.

In an aspect, the present disclosure is directed to, among other things, an article of manufacture having a unitary body structure. In an embodiment, the article of manufacture includes a first support element configured to engage one end of a paint roller of a first type. In an embodiment, the article of manufacture includes a second support element configured to engage one end of a paint roller of a second type, the second support element having a different configuration from the first support element. In an embodiment, the article of manufacture includes the unitary body structure includes a portion configured to engage the paint roller of the first type or the paint roller of the second type and to support the paint roller of the first type or the paint roller of the second type along a vertical direction.

In an aspect, the present disclosure is directed to, among other things, a single-body construction cleaner. In an embodiment, the single-body construction cleaner includes a standard paint roller inner surface engagement element. In an embodiment, the standard paint roller inner surface engagement element is configured to friction-fit to one end of a standard paint roller so as to retain water within a reservoir formed by the standard paint roller inner surface and the standard paint roller inner surface engagement element and to facilitate water to cascade over an outer surface of standard paint roller. In an embodiment, the single-body construction cleaner includes a mini paint roller inner surface engagement element. In an embodiment, the mini paint roller inner surface engagement element is configured to friction-fit to one end of a mini paint roller so as to retain water within a reservoir formed by the mini paint roller inner surface and the mini paint roller inner surface engagement element and to facilitate water to cascade over an outer surface of mini paint roller. In an embodiment, the single-body construction cleaner includes a base element. In an embodiment, the single-body construction cleaner is operable to support a standard paint roller or a mini paint roller in a vertical position.

### BRIEF DESCRIPTION OF THE FIGURES

FIG. 1A is a perspective of a paint roller cleaning system according one embodiment.

FIG. 1B is a perspective of a paint roller cleaning system according one embodiment.

FIG. 1C is a perspective of a paint roller cleaning system according one embodiment.

FIG. 1D is a perspective of a paint roller cleaning system according one embodiment.

FIG. 2A is an isometric view of a paint roller cleaning implement according one embodiment.

FIG. 2B is a top-plan view of a paint roller cleaning implement according one embodiment.

FIG. 2C is a front view of a paint roller cleaning implement according one embodiment.

FIG. 3 is a top-plan view of a paint roller cleaning implement according one embodiment.

FIG. 4A is a top-plan view of a paint roller cleaning implement according one embodiment.

FIG. 4B is an isometric view of a paint roller cleaning implement according one embodiment.

FIG. 4C is a side view of a paint roller cleaning implement according one embodiment.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

### DETAILED DESCRIPTION

Many paint rollers are designed to be reused, yet a substantial portion of then end up in landfills after a single day's use. Over two billion dollars' worth of paint rollers were sold worldwide in 2017, and that number is expected to exceed four billion dollars by 2026. Blended fabric paint rollers alone accounted for about 150 million units in 2017. See Trends Market Research, H. (n.d.). Global Paint Roller Market Industry Analysis and Forecast (2018-2026). Paint rollers are durable and when properly cleaned can be used multiple times. Unfortunately, most are discarded after one use and end up in landfills.

Certain prior art paint roller cleaning approaches require a drill and a water reservoir, or a hydro powered pressure setup to spray and spin the roller clean. These approaches, however, still have the problem of having to clean the cleaning of equipment.

In an embodiment, the disclosed methodologies or technologies are directed to inexpensive and sustainable ways to wash and reuse, or recycle, paint rollers. In an embodiment, the disclosed methodologies or technologies are directed to inexpensive and ease-of-used tools for cleaning paint rollers.

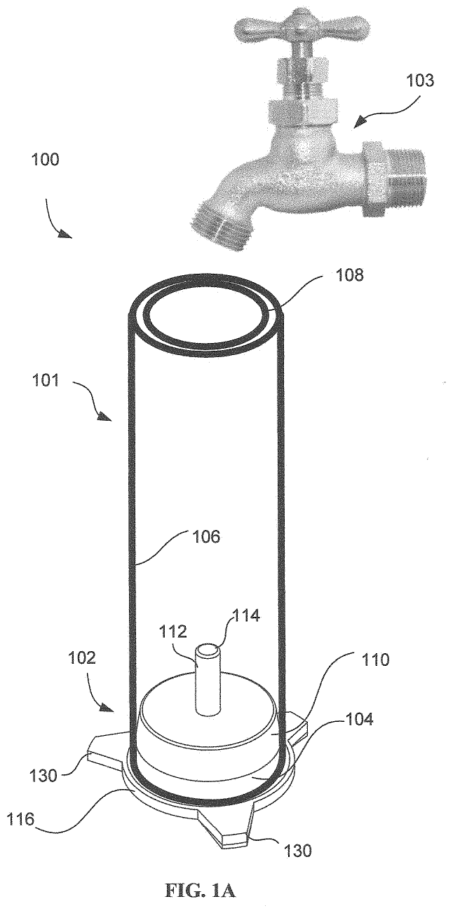

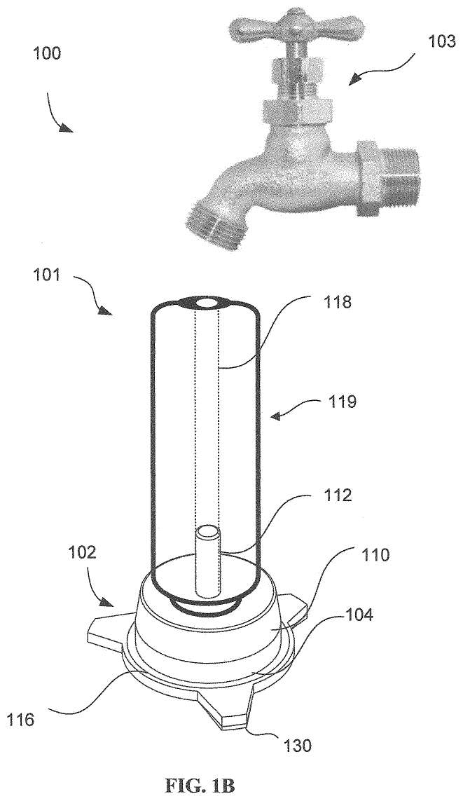

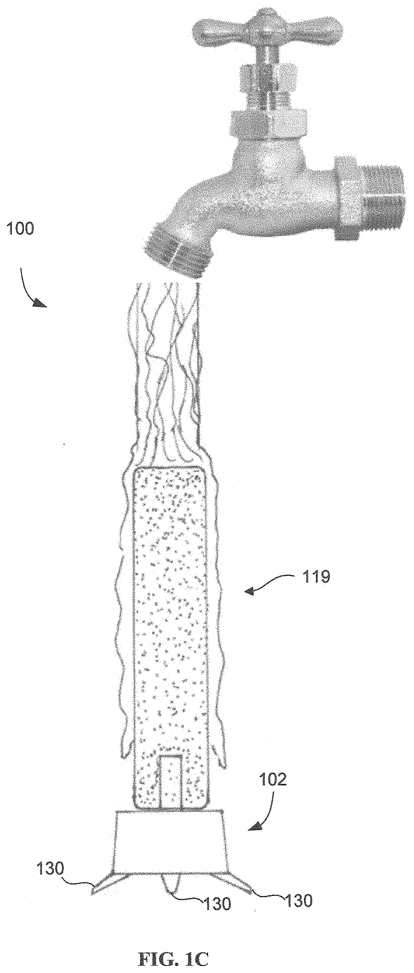

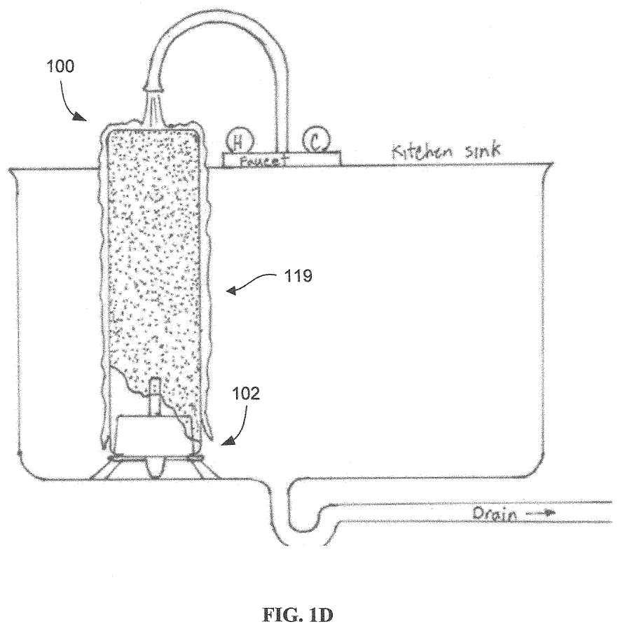

Paint rollers are durable and if properly washed can be saved and reused multiple times. FIG. 1A shows a paint roller cleaning system 100 in which one or more methodologies or technologies can be implemented such as, for example, cleaning water soluble paint off a paint roller 101 under a faucet 103, or the like.

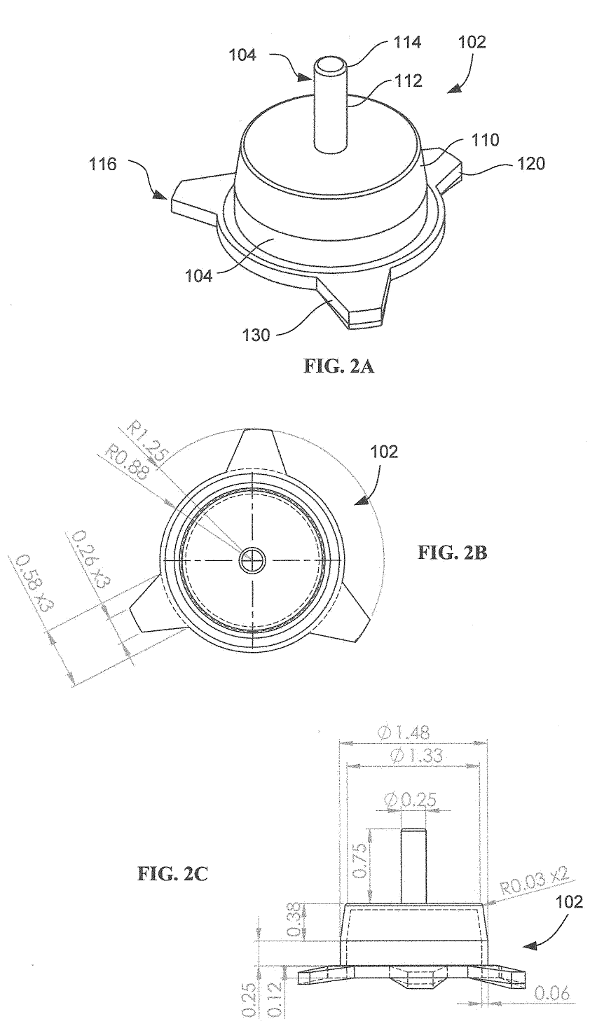

Referring to FIGS. 1A-1D and 2A-2C, in an embodiment, the paint roller cleaning system 100 includes paint roller cleaning implement 102.

In an embodiment, the paint roller cleaning element 102 includes a plurality of structures each sized and dimensioned to engage a paint roller of varying dimensions, formfactors, geometric configurations, sizes, or the like. For example, in an embodiment, the paint roller cleaning element 102 includes a first cylindrical structure 104 sized and dimensioned to engage an inner surface 106 of a paint roller frame 108 of a first size. In an embodiment, the first cylindrical structure 104 is sized and dimensioned to engage the inner surface of a standard paint roller frame. In an embodiment, a distal edged of the first cylindrical structure 104 comprises a beveled edge 110.

Referring to FIGS. 1A-1D, in embodiment, during use, the paint roller cleaning element 102 is configured to attach to a paint roller frame 108, seal off one end of the inner-surface paint roller frame 108, and support the paint roller frame 108 vertically. In an embodiment, the paint roller cleaning element 102 and the paint roller 101 are placed under a water faucet. Paint is washed off the paint roller 101 as the water fills the inner cavity of the paint roller frame and washes over the outer surfaced of the paint roller 101.

In an embodiment, a portion of the first cylindrical structure 104 is configured to friction fit to the inner surface 106 of the paint roller frame 108 of the first size and to form a water-tight seal. In an embodiment, a portion of the first cylindrical structure 104 is configured to fit within a standard paint roller frame and to form a seal sufficient to retain water received within a cavity of the standard paint roller frame. In an embodiment, a portion of the first cylindrical structure 104 is configured to fit within a standard paint roller frame and to form a seal sufficient to permit water to fill an inner cavity of the standard paint roller frame and cascade over an outer surface of a standard paint roller cover.

Referring to FIG. 16, in an embodiment, the paint roller cleaning element 102 includes a second cylindrical structure 112 sized and dimensioned to engage an inner surface 118 of a paint roller frame 119 of a second size different from the first. In an embodiment, the second cylindrical structure 112 is sized and dimensioned to engage the inner surface of a mini paint roller frame. In an embodiment, a distal edged of the second cylindrical structure 112 comprises a beveled edge 114. In an embodiment, a portion of the second cylindrical structure 112 is configured to friction fit to the inner surface 118 of the paint roller frame 119 of the second size and to form a water-tight seal. In an embodiment, a portion of the second cylindrical structure 112 is configured to fit within a mini paint roller frame and to form a seal sufficient to retain water received within a cavity of the mini paint roller frame. In an embodiment, a portion of the second cylindrical structure 112 is configured to fit within a mini paint roller frame and to form a seal sufficient to permit water to fill an inner cavity of the mini paint roller frame and cascade over an outer surface of a mini paint roller cover.

In an embodiment, the paint roller cleaning element 102 includes a base structure 116 configured to support and maintain a paint roller 101 vertically. In an embodiment, the base structure 116 includes a plurality of support elements 130 that stabilize paint roller cleaning implement 102 while is sits on a surface.

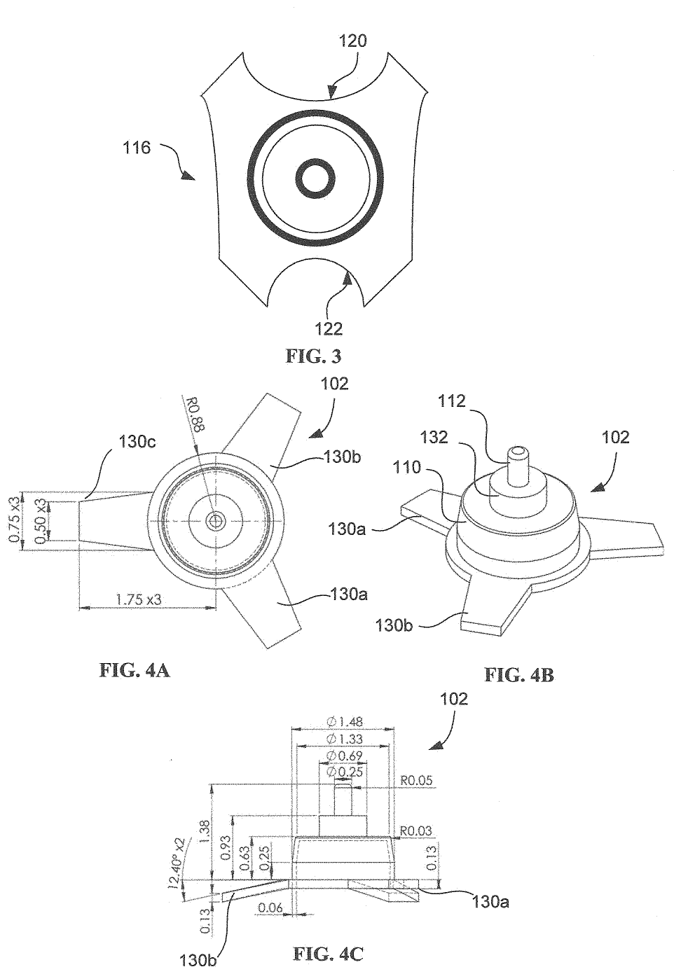

Referring to FIG. 3, in an embodiment, a portion of the base structure 116 comprises a squeegee or scaping element to help remove, squeegee, or scrape off paint from the paint roller surface. For example, in an embodiment, a portion of the base structure 116 comprises a concave structure 120 having an arc sized and dimensioned to fit over an outer contour of a standard paint roller so as to facilitate scraping of an outer surface of the standard paint roller. In an embodiment, a portion of the base structure 116 comprises a concave structure 122 having an arc sized and dimensioned to fit over an outer contour of a mini paint roller so as to facilitate scraping of an outer surface of the mini paint roller. In an embodiment, a portion of the base structure 116 comprises a concave structure 120 having an arc sized and dimensioned to fit over an outer contour of a standard paint roller so as to facilitate scraping of an outer surface of the standard paint roller; and a concave structure 122 having an arc sized and dimensioned to fit over an outer contour of a mini paint roller so as to facilitate scraping of an outer surface of the mini paint roller.

Referring to FIGS. 2A-2C, in an embodiment, the paint roller cleaning implement 102 comprises a one-piece construction. In an embodiment, the paint roller cleaning implement 102 comprises a single piece construction. In an embodiment, the first cylindrical structure 104 and the second cylindrical structure 112 are contiguous. In an embodiment, the first cylindrical structure 104 and the base structure 116 are contiguous. In an embodiment, the first cylindrical structure 104 and the second cylindrical structure 112 are centrically aligned about a common axis.

In an embodiment, the paint roller cleaning implement 102 includes a plurality of support elements 130 that stabilize paint roller cleaning implement 102 while is sits on a surface.

In an embodiment, the paint roller cleaning implement 102 is formed from one or more of plastic, polymers, glasses, resins, or the like, or mixtures thereof. In an embodiment, the paint roller cleaning implement 102 is formed from one or more thermoplastic or thermosetting resins. In an embodiment, the paint roller cleaning implement 102 is formed from one or more recycled materials. In an embodiment, the paint roller cleaning implement 102 is formed from one or more moldable plant-based materials. In an embodiment, the paint roller cleaning implement 102 is formed from cornstarch, coconut husks, paper, or starch-based polymers.

In an embodiment, the paint roller cleaning implement 102 is formed from biopolymer (e.g., liquid wood.) In an embodiment, the paint roller cleaning implement is formed from biodegradable polyesters (e.g., Polycaprolactone (PCL) polyesters).

In an embodiment, the paint roller cleaning implement 102 is formed from one or more of aluminum, steel, copper, brass, or the like, or mixtures thereof. In an embodiment, the paint roller cleaning implement 102 is formed from one or more metals, or amalgams thereof.

In an embodiment, the paint roller cleaning implement 102 is formed from hydrophobic materials. Non-limiting examples of hydrophobic materials include hydrophobic polymers, hydrophobic polyesters, hydrophobic metals, hydrophobic glasses, or the like. Further non-limiting examples of hydrophobic materials include acrylics, epoxies, polydimethylsiloxane, polyesters, polyethylene, polystyrene, polytetrafluorethylene, polyurethanes, polyvinylchloride, or the like. In an embodiment, the paint roller cleaning implement 102 comprises a hydrophobic coating.

In an embodiment, the paint roller cleaning implement 102 is formed by additive manufacturing. For example, the paint roller cleaning implement 102 is fabricated using a three-dimensional (3D) printer that prints layer by layer, using a variety of materials suitable for printing. In an embodiment, the paint roller cleaning implement 102 is formed by injection molding. In an embodiment, the paint roller cleaning implement 102 is formed from acrylonitrile butadiene styrenes, high density polyethylenes, polyamides, polycarbonates, polypropylenes, or the like, by injection molding. In an embodiment, the paint roller cleaning implement 102 is formed by a casting process.

Referring to FIGS. 4A-4C, in an embodiment, the paint roller cleaning implement 102 comprises a one-piece construction including one or more support elements 130a, 130b. 130c. In an embodiment, support elements are symmetrical, asymmetrical, can comprise an even or odd number, or have the same or different geometrical form, cross-section, construction, or the like. Referring to FIG. 4b, in an embodiment, at least one support element 130c extends parallel to the base of the part, to compensate for slope in a surface (e.g., a surface of a sink to drain, a resting surface, and the like).

Referring to FIG. 4C, in an embodiment, at least one support element is at an angle from a plane parallel to the base of cleaning implement 102. In an embodiment, at least one support element is at an angle ranging from about 1° to about 15° from a plane parallel to the base of cleaning implement 102. In an embodiment, at least one support element 130b is at an angle ranging from about 10° to about 14° to compensate for slope of sink to drain. In an embodiment, at least one support element 130b is at a 12.40 degree angle rom a plane parallel to the base of cleaning implement 102 to compensate for slope of sink to drain.

In an embodiment, the paint roller cleaning element 102 includes a plurality of structures each sized and dimensioned to engage a paint roller of a different size, type, construction, etc. Referring to FIG. 4B, in an embodiment, the paint roller cleaning element 102 includes a second cylindrical structure 112 sized and dimensioned to engage an inner surface 118 of a paint roller frame 119 of a second size different from the first. In an embodiment, the second cylindrical structure 112 is sized and dimensioned to engage the inner surface of a mini paint roller frame. In an embodiment, a distal edged of the second cylindrical structure 112 comprises a beveled edge 114. In an embodiment, a portion of the second cylindrical structure 112 is configured to friction fit to the inner surface 118 of the paint roller frame 119 of the second size and to form a water-tight seal. In an embodiment, a portion of the second cylindrical structure 112 is configured to fit within a mini paint roller frame and to form a seal sufficient to retain water received within a cavity of the mini paint roller frame. In an embodiment, a portion of the second cylindrical structure 112 is configured to fit within a mini paint roller frame and to form a seal sufficient to permit water to fill an inner cavity of the mini paint roller frame and cascade over an outer surface of a mini paint roller cover.

In an embodiment, the paint roller cleaning element 102 includes a third cylindrical structure 132 sized and dimensioned to engage an inner surface of a paint roller frame of a third size different from the first and second cylindrical structure. In an embodiment, the paint roller cleaning element 102 includes at least one structure 132 sized and dimensioned to engage an inner surface of a paint roller frame sold by WOOSTER® brand.

In an embodiment, an article of manufacture, comprises a unitary body structure, the unitary body structure including a first support element configured to engage one end of a paint roller of a first type; and a second support element configured to engage one end of a paint roller of a second type, the second support element having a different configuration from the first support element. In an embodiment, the unitary body structure is configured to engage the paint roller of the first type or the paint roller of the second type and to support the paint roller of the first type or the paint roller of the second type along a vertical direction.

In an embodiment, a single-body construction cleaner, comprises a standard paint roller inner surface engagement element; a mini paint roller inner surface engagement element; and a base element; wherein the single-body construction cleaner is operable to support a standard paint roller or a mini paint roller in a vertical position. In an embodiment, the standard paint roller inner surface engagement element is configured to friction-fit to one end of a standard paint roller so as to retain water within a reservoir formed by the standard paint roller inner surface and the standard paint roller inner surface engagement element and to facilitate water to cascade over an outer surface of standard paint roller. In an embodiment, the mini paint roller inner surface engagement element is configured to friction-fit to one end of a mini paint roller so as to retain water within a reservoir formed by the mini paint roller inner surface and the mini paint roller inner surface engagement element and to facilitate water to cascade over an outer surface of mini paint roller.

While particular aspects of the present subject matter described herein have been shown and described, it will be apparent to the reader that, based upon the teachings herein, changes and modifications can be made without departing from the subject matter described herein and its broader aspects and, therefore, the appended claims are to encompass within their scope all such changes and modifications as are within the true spirit and scope of the subject matter described herein. In general, terms used herein, and especially in the appended claims (e.g., bodies of the appended claims) are generally intended as “open” terms (e.g., the term “including” should be interpreted as “including but not limited to, “the term “having” should be interpreted as “having at least, “the term “includes” should be interpreted as “includes but is not limited to, “etc.). Further, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, such recitation should typically be interpreted to mean at least the recited number (e.g., the bare recitation of“two recitations,” without other modifiers, typically means at least two recitations, or two or more recitations). Furthermore, in those instances where a convention analogous to “at least one of A, B, and C, etc.” is used, in general such a construction is intended in the sense of the convention (e.g., “a system having at least one of A, B, and C” would include but not be limited to systems that have A alone, B alone, C alone, A and 8 together, A and C together, B and C together, and/or A, B, and C together, etc.). In those instances where a convention analogous to “at least one of A, B, or C, etc.” is used, in general such a construction is intended in the sense of the convention (e.g., “a system having at least one of A, B, or C” would include but not be limited to systems that have A alone, B alone, C alone, A and B together, A and C together, B and C together, and/or A, B, and C together, etc.). Typically, a disjunctive word or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, the operations recited therein generally may be performed in any order. Also, although various operational flows are presented in a sequence, it should be understood that the various operations may be performed in orders other than those that are illustrated, or may be performed concurrently. Examples of such alternate orderings includes overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A paint roller cleaning implement, comprising:
a first cylindrical structure sized and dimensioned to engage an inner surface of a paint roller frame of a first size;
at least a second cylindrical structure sized and dimensioned to engage an inner surface of a paint roller frame of a second size different from the first; and
a base structure configured to support and maintain a paint roller vertically.

2. The paint roller cleaning implement of claim 1, wherein
the first cylindrical structure is sized and dimensioned to engage the inner surface of a standard paint roller frame; and
the at second cylindrical structure is sized and dimensioned to engage the inner surface of a mini paint roller frame.

3. The paint roller cleaning implement of claim 1, wherein a distal edged of the first cylindrical structure comprises a beveled edge.

4. The paint roller cleaning implement of claim 1, wherein a portion of the first cylindrical structure is configured to fit within a standard paint roller frame and to form a seal sufficient to retain water received within a cavity of the standard paint roller frame; and wherein a portion of the second cylindrical structure is configured to fit within a mini paint roller frame and to form a seal sufficient to retain water received within a cavity of the mini paint roller frame.

5. The paint roller cleaning implement of claim 1, wherein a portion of the first cylindrical structure is configured to fit within a standard paint roller frame and to form a seal sufficient to permit water to fill an inner cavity of the standard paint roller frame and cascade over an outer surface of a standard paint roller cover.

6. The paint roller cleaning implement of claim 1, wherein a portion of the second cylindrical structure is configured to fit within a mini paint roller frame and to form a seal sufficient to permit water to fill an inner cavity of the mini paint roller frame and cascade over an outer surface of a mini paint roller cover.

7. The paint roller cleaning implement of claim 1, wherein a portion of the base structure comprises a concave structure having an arc sized and dimensioned to fit over an outer contour of a standard paint roller so as to facilitate scraping of an outer surface of the standard paint roller.

8. The paint roller cleaning implement of claim 1, wherein a portion of the base structure comprises a concave structure having an arc sized and dimensioned to fit over an outer contour of a mini paint roller so as to facilitate scraping of an outer surface of the mini paint roller.

9. The paint roller cleaning implement of claim 1, wherein a portion of the base structure comprises a concave structure having an arc sized and dimensioned to fit over an outer contour of a standard paint roller so as to facilitate scraping of an outer surface of the standard paint roller; and a concave structure having an arc sized and dimensioned to fit over an outer contour of a mini paint roller so as to facilitate scraping of an outer surface of the mini paint roller.

10. The paint roller cleaning implement of claim 1, wherein the paint roller cleaning implement comprises a single piece construction.

11. The paint roller cleaning implement of claim 1, wherein the first cylindrical structure and the second cylindrical structure are centrically aligned about a common axis.

12. The paint roller cleaning implement of claim 1, wherein the paint roller cleaning implement is formed from one or more recycled materials, or one or more hydrophobic materials.

13. The paint roller cleaning implement of claim 1, wherein the paint roller cleaning implement is formed from one or more moldable plant-based materials.

14. The paint roller cleaning implement of claim 1, wherein the paint roller cleaning implement is formed from a biopolymer.

15. The paint roller cleaning implement of claim 1, wherein the paint roller cleaning implement is formed from biodegradable polyesters.

16. An article of manufacture, comprising:
a unitary body structure, the unitary body structure including
a first support element configured to engage one end of a paint roller of a first type; and
at least a second support element configured to engage one end of a paint roller of a second type, the second support element having a different configuration from the first support element.

17. The article of manufacture of claim 16, wherein the unitary body structure is configured to engage the paint roller of the first type or the paint roller of the second type and to support the paint roller of the first type or the paint roller of the second type along a vertical direction.

18. A single-body construction cleaner, comprising:
a standard paint roller inner surface engagement element;
a mini paint roller inner surface engagement element; and
a base element;
wherein the single-body construction cleaner is operable to support a standard paint roller or a mini paint roller in a vertical position.

19. The single-body construction cleaner 18, wherein the standard paint roller inner surface engagement element is configured to friction-fit to one end of a standard paint roller so as to retain water within a reservoir formed by the standard paint roller inner surface and the standard paint roller inner surface engagement element and to facilitate water to cascade over an outer surface of standard paint roller.

20. The single-body construction cleaner 18, wherein the mini paint roller inner surface engagement element is configured to friction-fit to one end of a mini paint roller so as to retain water within a reservoir formed by the mini paint roller inner surface and the mini paint roller inner surface engagement element and to facilitate water to cascade over an outer surface of mini paint roller.
